(19) United States
(12) Patent Application Publication
(10) Pub. No.: US 2018/0306964 A1
(43) Pub. Date: Oct. 25, 2018

(54) TRANSPARENT LIGHTGUIDE

(71) Applicant: 3M INNOVATIVE PROPERTIES COMPANY, St. Paul, MN (US)

(72) Inventors: Bing HAO, Woodbury, MN (US); David A. ENDER, New Richmond, WI (US)

(21) Appl. No.: 15/525,405

(22) PCT Filed: Nov. 16, 2015
(86) PCT No.: PCT/US2015/060790

§ 371 Date: May 9, 2017

Related U.S. Application Data
(60) Provisional application No. 62/080,840, filed on Nov. 17, 2014.

(51) Int. Cl. F21V 8/00; G09F 13/02; G09F 19/12

(52) U.S. Cl. CPC G02B 6/0036; G09F 19/12; G09F 13/02; G02B 6/0061

(57) ABSTRACT

Optically transparent lightguides (200) including light extractors (230) with a maximum dimension of a projected area of each light extractor onto the lightguide less than 100 microns are disclosed. Each light extractor may be disposed in a different corresponding area cell (220) The plurality of light extractors extract light uniformly over the entire active region (210). Embodiments with a nearest neighbour distance of at least 100 microns and with an image behind the lightguide are also disclosed.

### BACKGROUND

Lightguides are used to transport, distribute, direct, and control the extraction of light over an output area. Lightguides include extractors which divert or reflect light such that the light can pass out of the lightguide and in some cases be viewed by a viewer. The configuration of the extractors affects characteristics of the overall illumination viewable from systems including these lightguides. Extractors typically need to be of such a size or such a density to provide acceptable light distribution that at least a portion of the lightguide appears hazy or distorting.

### SUMMARY

In one aspect, the present disclosure relates to an optically transparent lightguide. In particular, the optically transparent lightguide includes an active region and a plurality of discrete spaced apart light extractors disposed within the active region for extractive light that is otherwise confined in and propagates along the lightguide primarily by total internal reflection. Each light extractor includes one or more side walls and an inclined top wall, each side wall extending from the active region and making an angle of 10 degrees or less with a plane perpendicular to the active region, a maximum dimension of a projected area of each light extractor onto the active region being less than 100 microns, each light extractor disposed in a different corresponding area cell and occupying less than 30% of the area cell, the area cell of each light extractor having an interior portion enclosed by an a corresponding perimeter, the interior portion of the area of each light extractor not overlapping the interior portion of the area cell of any other light extractor, the plurality of light extractors extracting light uniformly over the entire active region such that when dividing the entire active region into 5 millimeter by 5 millimeter square areas, each square area includes at least one light extractor and a ratio to an amount of light exiting the lightguide from the square area to an area of the square area is within 20% of a ratio of an amount of light exiting the lightguide from the entire active region to the area of the entire active region.

In some embodiments, the active region is a convex shape. In some embodiments, the active region is continuous. In some embodiments, each of the area cells is a convex shape. In some embodiments, the area cell of at least one light extractor is greater than the area cell of at least one other light extractor. In some embodiments, all the area cells have the same area. In some embodiments, all the area cells have the same shape. In some embodiments, each light extractor includes at least two vertical sidewalls. In some embodiments, each light extractor includes at least three vertical sidewalls. In some embodiments, each light extractor varies by one or more of shape and size. In some embodiments, at least one light extractor has a wedge shape with a cylindrical sag. In some embodiments, the lightguide further includes a non-active region adjacent the active region, the non-active region not including any light extractors.

In another aspect, the present disclosure relates to a lightguide system. The lightguide system includes an optically transparent lightguide including a plurality of discrete spaced apart light extractors within an active region of the lightguide, a maximum dimension of a projected area of each light extractor onto the active region being less than 100 microns, one or more light sources disposed along one or more edges of the lightguide, the light extractors extracting light propagating within the lightguide from the one or more light sources, the extracted light exiting the lightguide toward a viewing position, and an image behind the lightguide and viewable through the lightguide from a viewing position in front of the lightguide, such that a majority of any light propagating within the lightguide primarily by total internal reflection that is extracted by the plurality of light extractors and exits the lightguide toward the viewer is not incident on the information layer before exiting the lightguide.

In some embodiments, the image extends beyond the lightguide. In some embodiments, the image comprises indicia. In some embodiments, the indicia includes at least one of a letter, a word, an alphanumeric, a symbol, a logo, a text, a picture, an image and a pattern. In some embodiments, the indicia comprises a static image. In some embodiments, the indicia comprises a dynamic image. In some embodiments, the image is an ambient image.

In yet another aspect, the present disclosure relates to an optically transparent lightguide. In particular, the optically transparent lightguide includes an active region and a plurality of discrete spaced apart light extractors disposed within the active region for extractive light that is otherwise confined in and propagates along the lightguide primarily by total internal reflection. Each light extractor includes one or more side walls and an inclined top wall, each side wall extending from the active region and making an angle of 10 degrees or less with a plane perpendicular to the active region, a maximum dimension of a projected area of each light extractor onto the active region being less than 100 microns, each light extractor having a nearest neighbor farther than 100 microns away, the plurality of light extractors extracting light uniformly over the entire active region such that when dividing the entire active region into 5 millimeter by 5 millimeter square areas, each square area includes at least one light extractor and a ratio to an amount of light exiting the lightguide from the square area to an area of the square area is within 20% of a ratio of an amount of light exiting the lightguide from the entire active region to the area of the entire active region.

### BRIEF DESCRIPTION OF THE DRAWINGS

FIGS. 1A-1D are top perspective views of exemplary light extractors for an optically transparent lightguide

FIG. 2 is a top plan view of an optically transparent lightguide.

FIG. 3 is a top plan view of another optically transparent lightguide

FIG. 4 is a top plan view of an optically transparent lightguide in front of an image.

### DETAILED DESCRIPTION

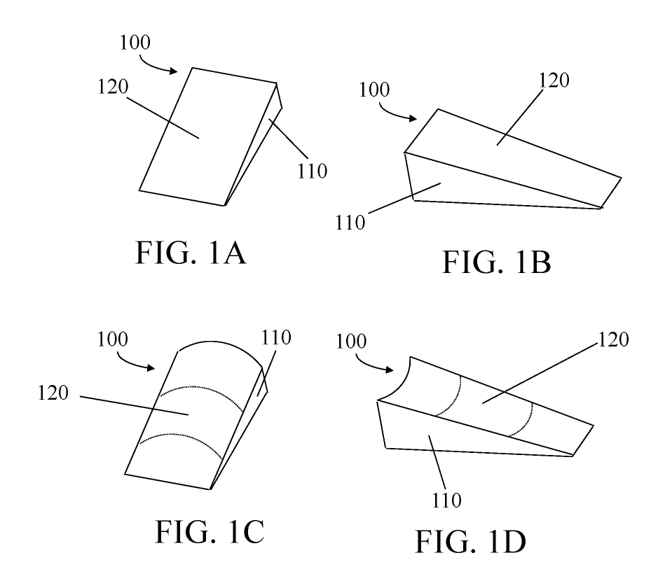

FIGS. 1A-1D are top perspective views of exemplary light extractors. Light extractor 100 includes one or more side walls 110 and inclined top wall 120. In some embodiments, light extractor 100 two side walls, and in some embodiments even more. Light extractor 100 may be any suitable shape. In some embodiments, light extractor 100 can be substantially wedge shaped, as depicted in FIGS. 1A-1D. Light extractor 100 may have side walls that are parallel or non-parallel. Each of one or more side walls 110 may be substantially planar or may be at least partially curved or faceted. Each of one or more side walls may be perpendicular to a plane of the lightguide or form an angle of 10 degrees or less with a plane perpendicular to the plane of the lightguide. For lightguides that are curved, non-planar, shaped, or molded, the plane of the lightguide may be a local tangent plane at the location of the lightguide. Light extractor 100 may further include a back wall and a bottom wall. In some embodiments, light extractor 100 is formed as an indentation in an otherwise solid lightguide (“innie”), obviating the need for a bottom wall. The size and shape of one or more side walls 110 is important to the overall shape of both inclined top wall 120 and the light extractor as a whole. Inclined top wall 120 may be substantially flat or planar or it may include negative or positive cylindrical sag. In this case, the inclined top wall may have a curved shape or surface in one direction but not along a second, orthogonal direction. In some embodiments, the extractor may be truncated (i.e., it may not fully taper to an edge).

Light extractor 100 may also have any suitable size. In some embodiments, light extractor 100 may be characterized by its projected area onto a lightguide. In some embodiments, the projected area of light extractor 100 may be substantially square or rectangular. In some embodiments, a maximum dimension of the projected area of light extractor 100 is less than 100 microns. In some embodiments, a maximum dimension of the projected area of light extractor 100 is less than 80, 50, or 20 microns.

Light extractor 100 may be configured to preferentially extract light within a range of extraction directions, which may correspond to certain viewing angles. For example, inclined top wall 120 may affect the range of angles extracted light travels along once extracted from a lightguide. Given the extractor shape and the refractive index differences between the light extractor (air if an indentation in an otherwise solid lightguide) and the lightguide, it is possible to model and predict the interaction of light with the faces of light extractor 100. In some embodiments, the light extractors may be high efficiency light extractors. High efficiency may be defined as the ratio of light incident on an extractor to light extracted by that extractor. This efficiency is affected mostly by shape and by the refractive index difference between the extractor and the lightguide. Extractor efficiency may also be direction dependent. For the exemplary extractor shapes depicted in FIGS. 1A-1D, the extractor may have a first extraction efficiency for light incident on inclined top wall 120, and a second extraction efficiency for light incident on one or more side walls 110, and the first extraction efficiency may be significantly higher than the first extraction efficiency. Direction-dependent light extractors are described in more detail in the co-owned Provisional Patent Application No. 61/922,217, filed on Dec. 31, 2013 and titled, “Lightguide Including Extractors with Directionally Dependent Extraction Efficiency.”

Light extractors may be formed by any suitable method and will usually be formed at the same time or process as a lightguide. For example, a substantially planar lightguide may have an extractor mold replicated into one or both of its major surfaces. This may be done through any suitable replication tool or master include the surface negative of the desired structure (whether the extractors are protruding or are recessed), such as a metal or silicone tool fabricated through any suitable process. Particularly for the small sizes of extractors herein, a master utilizing a multi-photon (or, specifically, two-photon) photolithographic process which is described in, for example, U.S. Pat. No. 7,941,013 (Marttila et al.), which has been incorporated by reference herein. The multi-photon photolithographic process involves imagewise exposing at least a portion of a photoreactive composition to light sufficient to cause simultaneous absorption of at least two photons, thereby inducing at least one acid- or radical-initiated chemical reaction where the composition is exposed to the light, the imagewise exposing being carried out in a pattern that is effective to define at least the surface of a plurality of light extraction structures. The lightguide may be cast against the master or replication tool and subsequently cured or hardened.

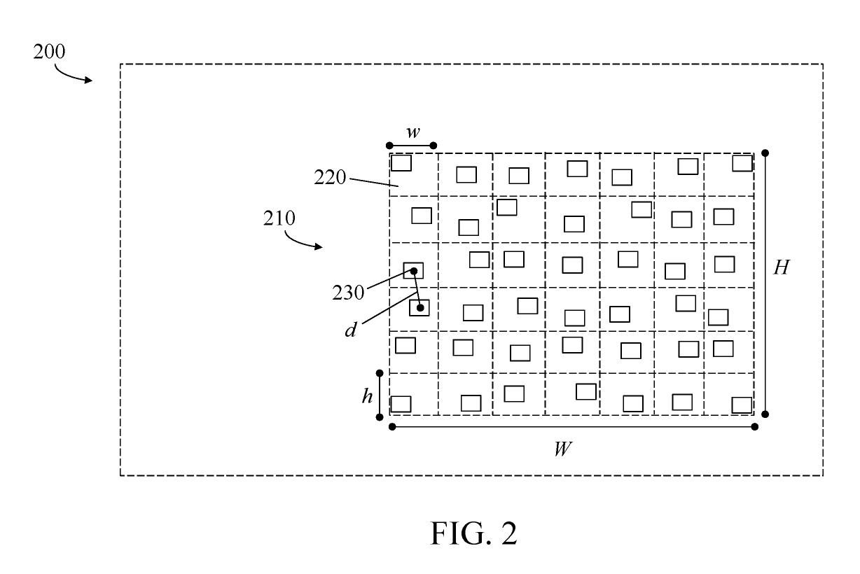

FIG. 2 is a top plan view of an optically transparent lightguide. Lightguide 200 includes active region 210 with a plurality of area cell 220 each including light extractor 230. Lightguide 200 is shown with broken lines for its boundary because the exact size and shape of lightguide 200 is not critical or even particularly relevant to the optical transparency of the lightguide.

In a straightforward case depicted in FIG. 2, each area cell 220 has an individual width w and an individual height h, and the overall active region 210 has a width W and a height H, and each of area cells 220 are arranged in a grid over the entire active area, such that W divided by the number of columns should equal w, and similarly for H and h for rows. Note that each of extractor 230 is not necessarily centered within the area cell 220.

Active region 210 may be defined as the convex (no internal angle greater than 180°) shape or set in two dimensions with minimum area required to include each of the light extractors on the lightguide. Alternatively, active region 210 may be defined as the convex shape with minimum area required to include each of the light extractors that are designed to be grouped together: in this sense there may be more than one active region on a lightguide. Usually, however, there is significant space between light extractor groups or the light extractor groups provide different types of information. In other words, the division between active regions on a lightguide should be clear from the design and application, and should not be arbitrarily chosen. Active region 210 may be coplanar with lightguide 200 or, for non-planar lightguides, it may follow its contour. In some embodiments with non-planar lightguides, the active region may be, from the perspective of an intended viewing position, the projection of the active surface onto a plane opposite the lightguide from the viewing position and perpendicular to a viewing axis. Area cell 220 need not be square and may in some embodiments be substantially circular, rectangular, elliptical, polygonal, or some other shape with curved or linear sides or boundaries. In some embodiments, as is depicted in FIG. 2, all of area cell 220 are the same size (area) and shape. In some embodiments, some or at least two of area cell 220 are the same area and/or shape. In some embodiments, all of area cells 220 are convex shapes. Area cell 220 may be characterized by an interior portion and a corresponding perimeter, where the perimeter encloses the interior portion. No interior portion should overlap the interior portion of another area cell. In some embodiments, the perimeter of at least one area cell overlaps with the perimeter of another area cell. Accordingly, each light extractor is in a different area cell. All of area cells should fill the space of active region 210 such that there is no portion of active region 210 that is not also included in an area cell. In some embodiments, active region 210 may include more than 100 light extractors, more than 1,000 light extractors, or more than 10,000 light extractors.

Alternatively, active region 210 and the placement of each of light extractor 230 therein may be characterized by each light extractor's nearest neighbor distance d. In some embodiments, d may be greater than 50 microns, 100 microns, 200 microns, or 500 microns. Accordingly, the placement of the light extractors in the active region may be characterized in that each light extractor's nearest neighbor is greater than a certain distance away. For purposes of this description, a nearest neighbor is the shortest distance between the centroids of each extractor projected onto the lightguide, the minimum distances for each extractor being its nearest neighbor distance.

In some embodiments, each light extractor 230 may be substantially the same size (i.e., within standard manufacturing error) and shape, or they may vary in size and/or shape. In some embodiments, the size of light extractor 230 may depend on its position in active region 210 and on lightguide 200. The placement, shape, and size of the light extractors within active region 210 may vary significantly depending on the application and may take into account the extraction efficiency of the lightguide, the transparency of the lightguide, and the extraction uniformity of the lightguide in the active region. In some embodiments, a maximum dimension of the projected area of each of the light extractors is less than 100 microns. In some embodiments, the projected area of each of the light extractors is less than 30% of the area of its corresponding area cell. In some embodiments, the projected area of each of the light extractors is less than 25%, 20%, or even 10% of the corresponding area cell. Also, depending on the application, some or all of the light extractors may be orientated differently, especially those light extractors that may have directionally dependent light extraction efficiencies: this can be an effective way to finely control the extraction efficiencies of different areas of the active region.

Active region 210 may have substantially uniform light extraction. Substantially uniform light extraction may be characterized by superimposing a grid of 5 millimeter by 5 millimeter square areas on top of the active region. Within these 5 mm×5 mm square areas, each square area includes a light extractor and extracts within 20% of the light expected from a perfectly uniform extraction; that is, the area of the square area divided by the total area of active region 210 multiplied by the total light extracted by active region 210. The range of +/−20% will in many applications be acceptable to a viewer and appear uniform; however, for some applications, there may be a need for tighter tolerances, for example, for each square area to extract within 10% or 5% of the total light extracted by the active region.

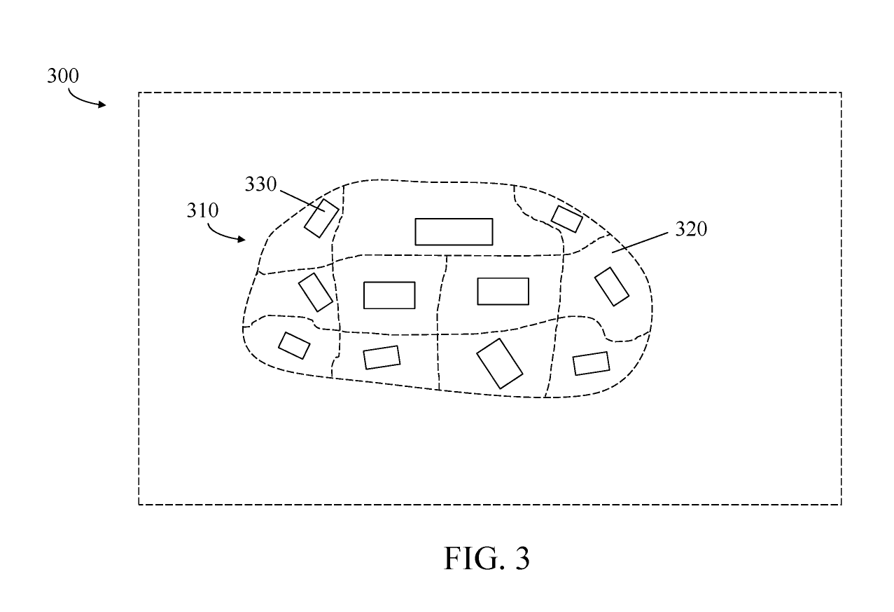

FIG. 3 is a top plan view of another optically transparent lightguide that illustrates some of the design flexibility for lightguides disclosed herein. For example, in FIG. 3, lightguide 300 includes active region 310 including a plurality of area cell 320, each including light extractor 330; however, the area cells and light extractors have different shapes, sizes, and orientations. For example, several larger cells might include a light extractor that is much bigger than would be possible for light extractors in smaller cells (still within any limit on a maximum dimension of a light extractor). This is permissible because the projected area of the light extractor on the active region is still less than a desired fraction. For lightguide 300, the active region should also still exhibit uniformity, characterized by the 5 mm×5 mm grid as described for FIG. 2. As previous discussed for lightguide 200 of FIG. 2, there may be, regardless of the size distribution of light extractors 330, a maximum dimension for the projected area of the light extractors onto active region 310, such as 100 microns.

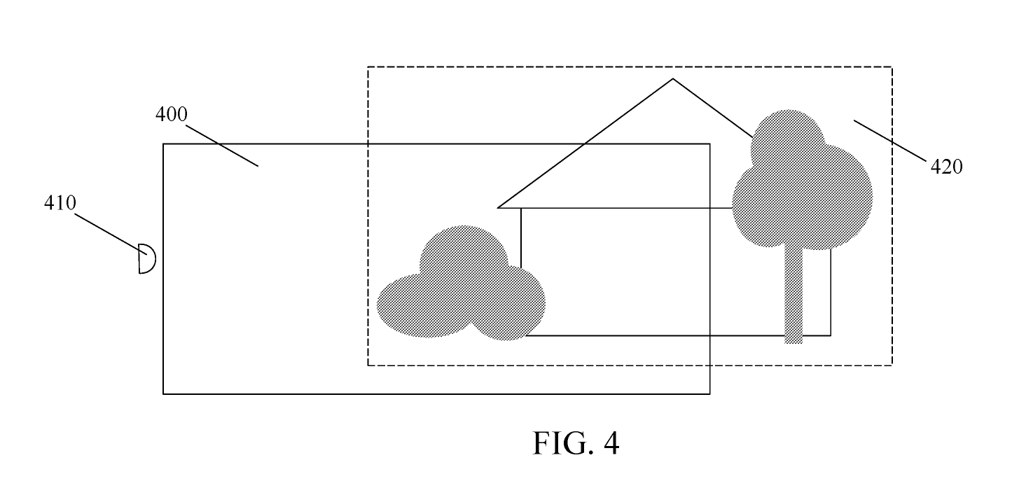

FIG. 4 is a top plan view of an optically transparent lightguide in front of an image. Lightguide 400 receives light from one or more light sources 410 and is placed in front of image 420. Lightguide 400 is an optically transparent lightguide with an active region as described in conjunction with FIGS. 2 and 3. Lightguide 400 may be considered optically transparent even though it may be difficult to see through while bright extracted light is directed toward the viewer. One or more light sources 410 may be any suitable number and type of light sources, and may include light emitting diodes (or organic light emitting diodes), compact fluorescent light sources, cold cathode fluorescent lamps, incandescent bulbs, or any combination thereof. In some embodiments, the one or more light sources may be configured to emit substantially white light, although any desired spectral power distribution may be used, including non-visible wavelengths. In some embodiments, one or more light sources 410 includes appropriate injection optics, including in some embodiments being optically coupled to the lightguide, in order to minimize Fresnel losses at the refractive index threshold at the boundary of the lightguide.

Light from the one or more light source 410 is transported within the lightguide 400 through total internal reflection and may be directed outwards (from the perspective in FIG. 4, likely out of the page) toward a viewer. In some embodiments, image 420 is visible through lightguide 400. In some embodiments, image 420 extends beyond the boundaries of lightguide 400 (in this respect, lightguide 400 is shown with solid lines as its boundaries, although as described elsewhere it may be any suitable shape and not limited to a substantially rectangular shape as shown in FIG. 4). In some embodiments, image 420 extends beyond the boundaries of an active region of lightguide 400, although the image may not extend beyond the boundaries of the entire lightguide. In some embodiments, lightguide 400 is like a window and image 420 is an ambient image or scene. In some embodiments, image 420 includes information and may be a poster, advertisement, or piece of art. In some embodiments, image 420 includes words, letters, numbers, or other indicia, such as a logo or a trademark. An active region of lightguide 400 may be aligned with a portion of image 420 designed to draw a viewer's attention to a certain location or provide information through selective illumination. In some embodiments, a majority of the light being transported within lightguide 410 by total internal reflection and extracted by the plurality of light extractors in the active area of the lightguide exits the lightguide without being incident on the image. Signage, general or decorative illumination, including lamps and luminaires, transparent lighting such as automotive sunroofs, windows, and skylights that can be selectively illuminated are contemplated and may include the optically transparent lightguides and configurations described herein.

The following are items of the present disclosure.

Item 1 is an optically transparent lightguide comprising an active region and a plurality of discrete spaced apart light extractors disposed within the active region for extracting light that is otherwise confined in and propagates along the lightguide primarily by total internal reflection, each light extractor comprising one or more side walls and an inclined top wall, each side wall extending from the active region and making an angle of 10 degrees or less with a plane perpendicular to the active region, a maximum dimension of a projected area of each light extractor onto the active region being less than 100 microns, each light extractor disposed in a different corresponding area cell and occupying less than 30% of the area cell, the area cell of each light extractor having an interior portion enclosed by a corresponding perimeter, the interior portion of the area cell of each light extractor not overlapping the interior portion of the area cell of any other light extractor, the plurality of light extractors extracting light uniformly over the entire active region such that when dividing the entire active region into 5 millimeter by 5 millimeter square areas, each square area includes at least one light extractor and a ratio of an amount of light exiting the light guide from the square area to an area of the square area is within 20% of a ratio of an amount of light exiting the light guide from the entire active region to the area of the entire active region.

Item 2 is the lightguide of item 1, wherein the active region is a convex shape.

Item 3 is the lightguide of item 1, wherein the active region is continuous.

Item 4 is the lightguide of item 1, wherein each of the area cells is a convex shape.

Item 5 is the lightguide of item 1, wherein the area cell of at least one light extractor is greater than the area cell of at least one other light extractor.

Item 6 is the lightguide of item 1, wherein all the area cells have the same area.

Item 7 is the lightguide of item 1, wherein all the area cells have the same shape.

Item 8 is the lightguide of item 1, wherein each light extractor comprises at least two vertical sidewalls.

Item 9 is the lightguide of item 1, wherein each light extractor comprises at least three vertical sidewalls.

Item 10 is the lightguide of item 1, wherein each light extractor varies by one or more of shape and size.

Item 11 is the lightguide of item 1, wherein at least one light extractor has a wedge shape with a cylindrical sag.

Item 12 is the lightguide of item 1 comprising a non-active region adjacent the active region, the non-active region not comprising any light extractors.

Item 13 is a lightguide system comprising:

an optically transparent lightguide comprising a plurality of discrete spaced apart light extractors within an active region of the lightguide, a maximum dimension of a projected area of each light extractor onto the active region being less than 100 microns;

one or more light sources disposed along one or more edges of the lightguide, the light extractors extracting light propagating within the lightguide from the one or more light sources, the extracted light exiting the lightguide toward a viewing position; and

an image behind the lightguide and viewable through the lightguide from a viewing position in front of the lightguide, such that a majority of any light propagating within the lightguide primarily by total internal reflection that is extracted by the plurality of light extractors and exits the lightguide toward the viewer is not incident on the image before exiting the lightguide.

Item 14 is the lightguide system of item 13, wherein the image extends beyond the lightguide.

Item 15 is the lightguide system of item 13, wherein the image comprises indicia.

Item 16 is the lightguide system of item 15, wherein the indicia comprises at least one of a letter, a word, an alphanumeric, a symbol, a logo, a text, a picture, an image and a pattern.

Item 17 is the lightguide system of item 15, wherein the indicia comprises a static image.

Item 18 is the lightguide system of item 15, wherein the indicia comprises a dynamic image.

Item 19 is the lightguide system of item 13, wherein the image is an ambient image.

Item 20 is an optically transparent lightguide comprising an active region and a plurality of discrete spaced apart light extractors disposed within the active region for extracting light that is otherwise confined in and propagates along the lightguide primarily by total internal reflection, each light extractor comprising one or more side walls and an inclined top wall, each side wall extending from the active region and making an angle of 10 degrees or less with a plane perpendicular to the active region, a maximum dimension of a projected area of each light extractor onto the active region being less than 100 microns, each light extractor having a nearest neighbor farther than 100 microns away, the plurality of light extractors extracting light uniformly over the entire active region such that when dividing the entire active region into 5 millimeter by 5 millimeter square areas, each square area includes at least one light extractor and a ratio of an amount of light exiting the light guide from the square area to an area of the square area is within 20% of a ratio of an amount of light exiting the light guide from the entire active region to the area of the entire active region.

Descriptions for elements in figures should be understood to apply equally to corresponding elements in other figures, unless indicated otherwise. The present invention should not be considered limited to the particular embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

1-10. (canceled)

11. An optically transparent lightguide comprising an active region and a plurality of discrete spaced apart light extractors disposed within the active region for extracting light that is otherwise confined in and propagates along the lightguide primarily by total internal reflection, each light extractor comprising one or more side walls and an inclined top wall, each side wall extending from the active region and making an angle of 10 degrees or less with a plane perpendicular to the active region, a maximum dimension of a projected area of each light extractor onto the active region being less than 100 microns, each light extractor disposed in a different corresponding area cell and occupying less than 30% of the area cell, the area cell of each light extractor having an interior portion enclosed by a corresponding perimeter, the interior portion of the area cell of each light extractor not overlapping the interior portion of the area cell of any other light extractor, the plurality of light extractors extracting light uniformly over the entire active region such that when dividing the entire active region into 5 millimeter by 5 millimeter square areas, each square area includes at least one light extractor and a ratio of an amount of light exiting the light guide from the square area to an area of the square area is within 20% of a ratio of an amount of light exiting the light guide from the entire active region to the area of the entire active region.

12. The lightguide of claim 11, wherein the active region is a convex shape.

13. The lightguide of claim 11, wherein the active region is continuous.

14. The lightguide of claim 11, wherein each of the area cells is a convex shape.

15. The lightguide of claim 11, wherein the area cell of at least one light extractor is greater than the area cell of at least one other light extractor.

16. The lightguide of claim 11, wherein all the area cells have the same area.

17. The lightguide of claim 11, wherein all the area cells have the same shape.

18. The lightguide of claim 11, wherein each light extractor comprises at least two vertical sidewalls.

19. The lightguide of claim 11, wherein each light extractor comprises at least three vertical sidewalls.

20. The lightguide of claim 11, wherein each light extractor varies by one or more of shape and size.

21. The lightguide of claim 11, wherein at least one light extractor has a wedge shape with a cylindrical sag.

22. The lightguide of claim 11 comprising a non-active region adjacent the active region, the non-active region not comprising any light extractors.

23. A lightguide system comprising:
an optically transparent lightguide comprising a plurality of discrete spaced apart light extractors within an active region of the lightguide, a maximum dimension of a projected area of each light extractor onto the active region being less than 100 microns;
one or more light sources disposed along one or more edges of the lightguide, the light extractors extracting light propagating within the lightguide from the one or more light sources, the extracted light exiting the lightguide toward a viewing position; and
an image behind the lightguide and viewable through the lightguide from a viewing position in front of the lightguide, such that a majority of any light propagating within the lightguide primarily by total internal reflection that is extracted by the plurality of light extractors and exits the lightguide toward the viewer is not incident on the image before exiting the lightguide.

24. The lightguide system of claim 23, wherein the image extends beyond the lightguide.

25. The lightguide system of claim 23, wherein the image comprises indicia.

26. The lightguide system of claim 25, wherein the indicia comprises at least one of a letter, a word, an alphanumeric, a symbol, a logo, a text, a picture, an image and a pattern.

27. The lightguide system of claim 25, wherein the indicia comprises a static image.

28. The lightguide system of claim 25, wherein the indicia comprises a dynamic image.

29. The lightguide system of claim 23, wherein the image is an ambient image.

30. An optically transparent lightguide comprising an active region and a plurality of discrete spaced apart light extractors disposed within the active region for extracting light that is otherwise confined in and propagates along the lightguide primarily by total internal reflection, each light extractor comprising one or more side walls and an inclined top wall, each side wall extending from the active region and making an angle of 10 degrees or less with a plane perpendicular to the active region, a maximum dimension of a projected area of each light extractor onto the active region being less than 100 microns, each light extractor having a nearest neighbor farther than 100 microns away, the plurality of light extractors extracting light uniformly over the entire active region such that when dividing the entire active region into 5 millimeter by 5 millimeter square areas, each square area includes at least one light extractor and a ratio of an amount of light exiting the light guide from the square area to an area of the square area is within 20% of a ratio of an amount of light exiting the light guide from the entire active region to the area of the entire active region.
